(19) United States
(12) Patent Application Publication
(10) Pub. No.: US 2006/0254898 A1
(43) Pub. Date: Nov. 16, 2006

(54) HAPTIC DATA INPUT DEVICE

(76) Inventor: John L. O'Leary, Edmonds, WA (US)

Correspondence Address: HALLISKY & PHILIPP, 1725 WESTLAKE AVENUE NORTH, SUITE 150, SEATTLE, WA, 98109, US

(21) Appl. No.: 11/382,539

(22) Filed: May 10, 2006

Related U.S. Application Data
(60) Provisional application No. 60/594,843, filed on May 11, 2005.

(51) Int. Cl. H01H 3/40

(52) U.S. Cl. 200/500

(57) ABSTRACT

A haptic data input device is shown and described.

### BACKGROUND

Most computer keyboards are based upon designs developed for mechanical typewriters that are bulky and counterintuitive. Smaller versions are typically difficult to manipulate, especially for individuals with large fingers. People using thumb key pads on PDAs cannot replicate the typing speeds of those who are skilled in using traditional full size keyboards. There are also indications that repetitive stress injuries are becoming a common result of over use of PDA style thumb key pads. Numeric key pads on portable phones require multiple keystrokes to create single characters, an inefficient way to communicate via text.

### SUMMARY

The haptic data input device as presented here has examples and applications far beyond those than can be reasonably described in this document. The unfortunate result of providing examples is that it can limit the imagination when considering potential uses. Consider the following two statements:
Direct feedback stimulation could be useful in educational, medical, and rehabilitative situations.
Direct feedback stimulation could be useful in educational, medical, and rehabilitative situations (specifically referenced in Examples 1 and 7).

The first suggests broad possibilities that are severely limited after considering the examples referenced in the second statement. It is important to remember that the device could be used on any piece of skin depending on the needs of the user and the function for which it is being used. This may include the areas already described herein, and also the shoulder, torso, scalp, face, ears, neck, lips, palms, lower legs, and feet. The device could be used for a wide variety of purposes ranging from those benefiting from direct feedback stimulation to those used to operate remote devices:
Direct feedback stimulation could be useful in educational, medical, and rehabilitative situations (specifically referenced in Examples 1 and 7).
People with physical and mental challenges could utilize the device to operate assistive technologies (specifically referenced in Example 7).
The device could be used to operate many of the modern tools and conveniences people use today (some of which have been referred to in many of the examples herein).
There are applications that may provide secure access to tools, equipment, and other items (specifically referenced in Example 2).
There are applications that may enhance personal security and safety (specifically referenced in Examples 6.3-4).
Finally, there are specialized uses that may be developed to assist users in operating surgical, laboratory, construction, hazmat, assembly, engineering, transportation, research, or other specialized tools or operations.

### DETAILED DESCRIPTION

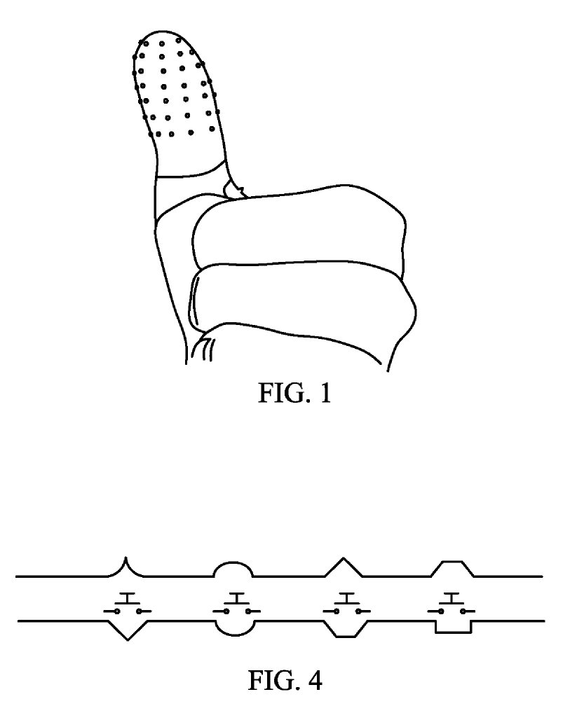

Because the “map” of one's thumb is relatively large in the brain it is possible to have numerous small nibs close to one another—as close as three millimeters in more sensitive areas. For comparison, Braille is usually less than 2.6 millimeters from dot to dot. See for example FIG. 1, a “Thumb keyboard.”

The haptic data input device provides a way to reduce the size and complexity of data input devices such as numeric keypads, computer keyboards, and home electronic remotes by providing haptic feedback on the surface of the user's skin.

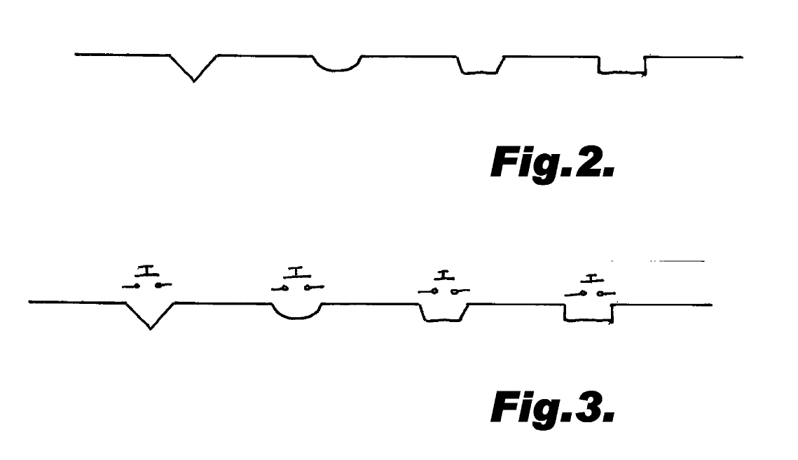

One feature of the haptic data input device is a tactile sensation producing element on or near the skin that can be activated when pressure is applied to the device. An example of the tactile sensation producing element can be a shaped protrusion with or without stimulus augmentation such as temperature changes or a mild electrical charge. In some circumstances the tactile sensation producing element may not use a protrusion in order to augment the haptic stimulus. An example may be construction with a flexible material that allows a large amount of the full force of the pressure to be felt through the device to the skin of the user. This example illustrates that flexibility may serve as a tactile sensation producing element. Other examples may rely on skin surface sensitivity to sensations other than pressure such as temperature, vibration, and mild electrical stimulation. Other sensory elements may also be used to augment the haptic stimulus depending on the needs of the user, including but not limited to; sound, light, odor, and flavor. FIG. 2 shows four different examples of protruding tactile sensation producing elements with the skin surface being below the elements in this illustration.

Depending on the area of skin surface to be stimulated and its sensitivity to touch, different shapes on the tactile sensation producing elements, such as those illustrated in FIG. 2, as well as other shapes and variations may be able to balance the user's need to be sensitive to the stimulus and yet maintain a sense of comfort. Different spacing and different materials may also be used to help maintain the balance between sensitivity and comfort.

Another exemplary feature of the haptic data input device is the switching mechanism. The switch may be activated when pressure is applied to the location above the tactile sensation producing element. Examples of switches that may be useful in various applications include membrane switches, mechanical switches, diaphragm switches and electrostatic switches. FIG. 3 shows examples of possible switch locations relative to the tactile sensation producing elements.

Other possible switch locations may be on the upper or lower surface, for example when utilizing electrostatically sensitive switches that are triggered through contact with the conductive skin surface.

The upper surface of the exemplary haptic data input devices may or may not have protrusions depending on the application and the needs of the user. In the example of a “thumb keyboard” as illustrated in FIG. 1, the protrusions on the upper surface help provide reference points for the user's finger tips. FIG. 4 shows examples of protrusions on the upper surface of haptic data input devices that help the user locate the site of the corresponding switch.

Examples of upper surfaces that may not require protrusions include haptic data input devices that are integrated into clothing or are worn underneath clothing.

An electronic circuit transmits the information about whether the circuit is open or closed to a processor. The electronic circuit can take many forms based upon available technology, the type of haptic data input device being utilized, and the needs of the user. Circuits could be hard wired to a processor or routed to devices that would be able to transmit and receive the signal en route to a processor. Such transmission devices could comprise any existing or future technology that is appropriate to the application being considered. Examples would include, but not be limited to; infrared in the case of remotes similar to those used for home electronics; FM radio used in portable telephones and other applications; digital and analog transmissions used in cell phones; and, Bluetooth as an example of new standards in electronic wireless communication.

The complexity and length of the electronic circuit would depend upon how the device is being used. An example of a relatively simple application would be a “kill switch” where a single switch haptic data input device is connected directly to a transmitter and the receiver and simple processor is integrated with a piece of power machinery. More complex examples would include, but not be limited to; phone numeric keypads; home electronic remote keypads; game controllers for electronic video games; keyboards for PDAs; full feature keyboards for computers; and expanded keyboards for non-Romanized writing systems. Specialized examples would be for device specific commands such as for power wheelchairs; medical equipment; and manufacturing tools and equipment.

Some overall considerations for the haptic data input device are that the haptic aspect can be achieved through a variety of methods. With extremely thin materials, similar in feel to rubber gloves, the haptic stimulus will be easily transmitted through the material to the skin of the user simply by the application of pressure. With thicker materials there may be a need to augment the transmission of the haptic stimulus from the upper surface to the surface of the skin of the user. This could be accomplished through simple mechanical means or could be done through electronic transmission to a tactile sensation producing element. There may be eventual applications where one may use the input portion of a haptic data input device in one location on or near the body while the tactile sensation producing elements are activated on another location on the body.

There are a broad variety of applications for haptic data input devices.

### EXAMPLE 1

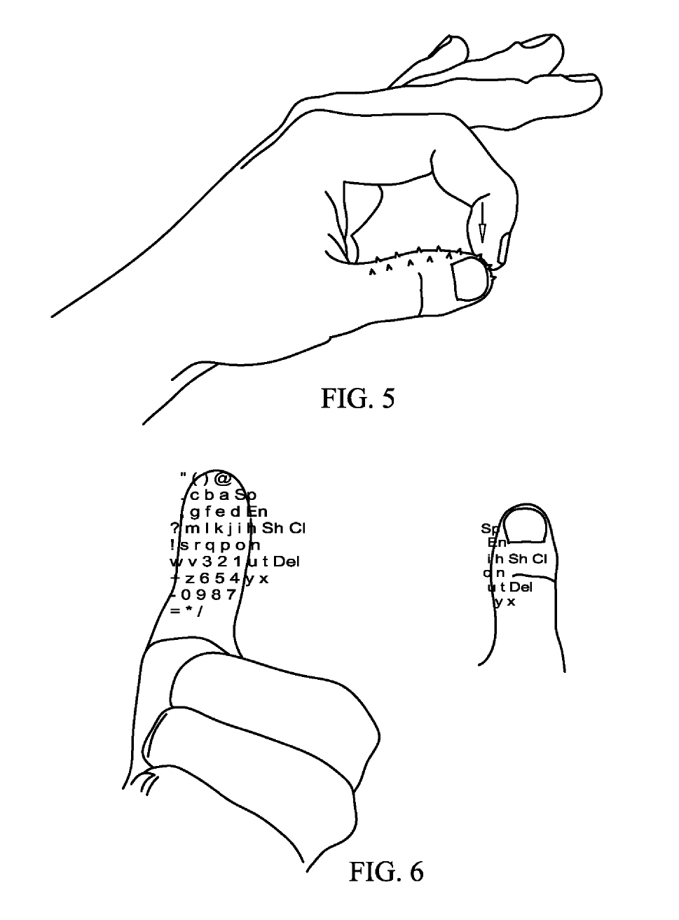

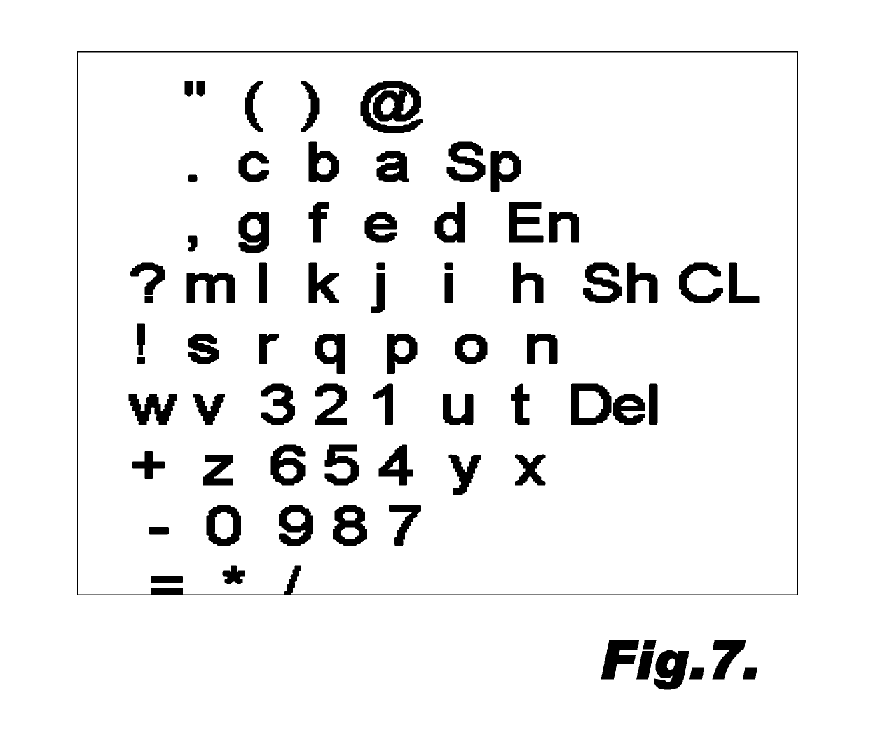

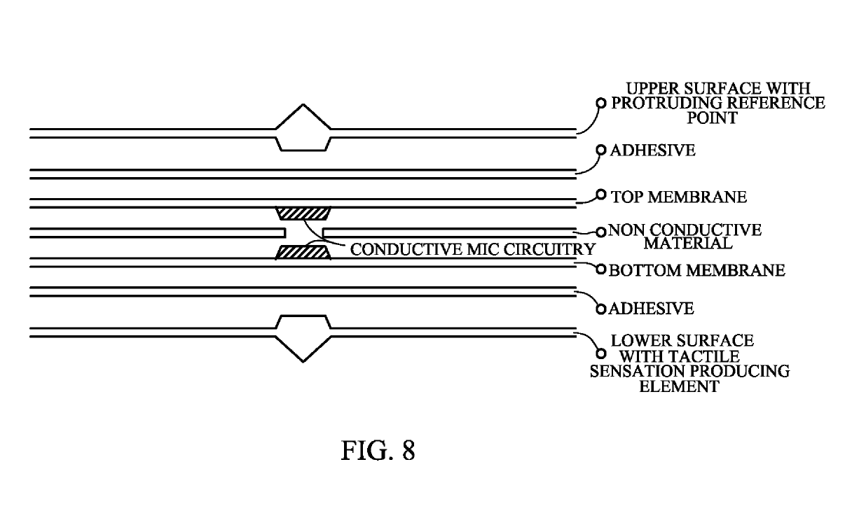

The “thumb keyboard” as illustrated in FIGS. 1 and 5-8
FIG. 5 illustrates pressing a nib on a “thumb keyboard.”
FIG. 6 illustrates a possible keyboard layout.
FIG. 7 illustrates an enlarged keyboard layout (Sp=space En=Enter Sh=shift CL=caps lock Del=delete).
FIG. 8 illustrates a cross section of an exemplary membrane switch with tactile sensation producing element and protruding reference point.

An example is the “thumb keyboard” illustrated in FIGS. 1 and 5-8 that could be used with cell phones, PDAs, computers, and any device that transmits or utilizes text input. It may have a layout similar to that shown in FIGS. 6 and 7. Spacing between the switches in one example may range between 3 and 8 millimeters.

FIG. 8 provides a cross section view of a membrane switch design that includes tactile sensation producing elements and protruding reference points. The overall matrix within which the switches lie would be an elastic material that would allow the tactile sensation producing elements to fit snugly against the skin.

The user would use his or her fingertips to press the outer protrusions thereby closing the switch and transferring the pressure to the tactile sensation producing element that transfers the pressure to the skin of the thumb. The closed switch closes the circuit, transmitting a signal to the processor. The sensation produced by the tactile sensation producing element will provide sensory feedback to the skin surface of the thumb of the user confirming that the switch was compressed and that the location was correct for the function desired.

The “thumb keyboard” illustrated in FIGS. 1 and 5-8 could be configured in a mirror image for each thumb—the above configuration would be for a left thumb and a mirror image would be for the right thumb. This example could also be simplified to a numeric keypad, electronic remote, or specialized device input by assembling with fewer switches. The “thumb keyboard” may be fitted (or associated) with a screen on the thumbnail or other location in order to view several characters of text or other visual feedback when the user needs visual confirmation of the data being input. An audio element may also be useful in some circumstances.

The advantages of the “thumb keyboard” as illustrated in FIGS. 1 and 5-8 are that it can be used single handedly, it is small and utilizes few materials, the thumb is still available to be used for other purposes, the range of motion for the fingers to operate it is reduced compared to other keyboards, it can be used discretely and unobtrusively, it can be worn on the thumb or as part of a glove so it does not need to be retrieved from a pocket or other location when being utilized frequently, it can be worn under a glove or mitten when needed. In a specialized application it could be used by patients in hospital to call for assistance, adjust their bed, turn on radio, TV, etc.

### EXAMPLE 2

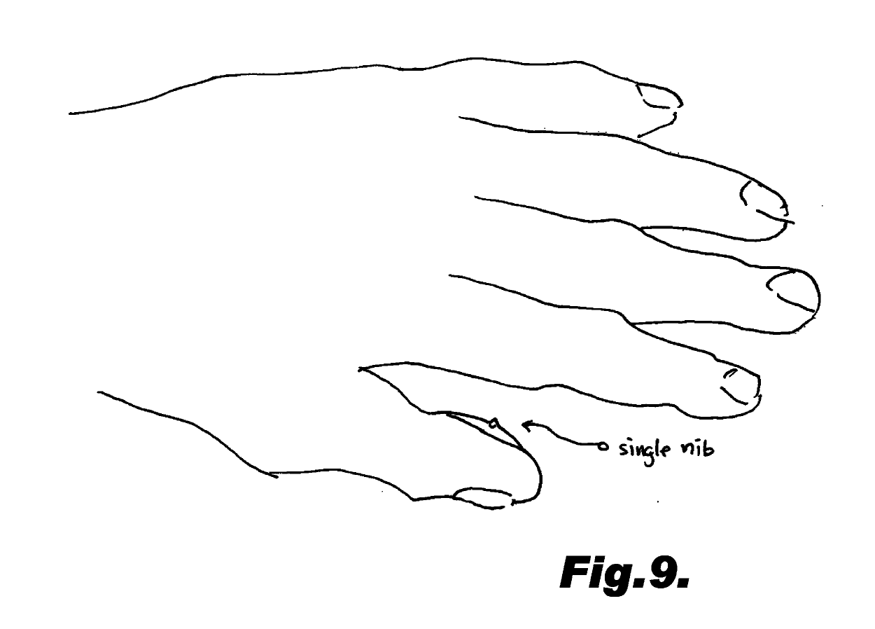

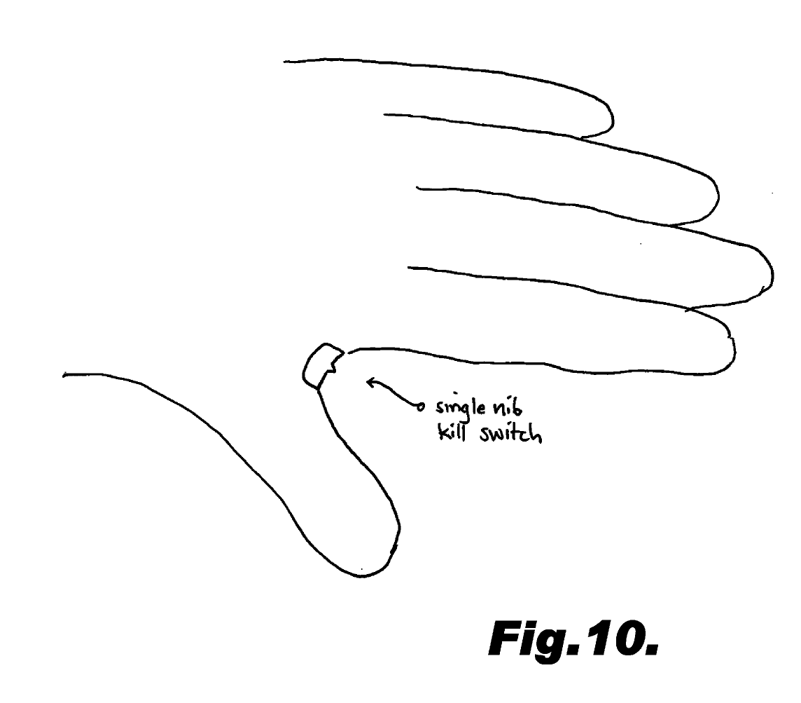

“Kill switch”—passive as illustrated in FIGS. 9 and 10
FIG. 9 illustrates a passive kill switch on a thumb
FIG. 10 illustrates a passive kill switch between thumb and index finger

The passive kill switch is an example of a simple haptic data input device that may have a wide variety of uses. The switch could be fastened to the hand by any variety of methods including, but not limited to, gloves, elastic, adhesive (similar to an adhesive bandage), etc. FIG. 9 illustrates the passive kill switch on the thumb. FIG. 10 illustrates the passive kill switch positioned between the thumb and the index finger. Pressure on the switch by holding the tool firmly would close the switch, sending a signal to a processor within the tool, allowing the tool to be operated. Releasing the tool would release pressure on the switch, opening the circuit and turning off the tool. The user would have constant feedback through the pressure of the tactile sensation producing element on the skin as to how firmly the tool is being grasped.

Advantages of the passive kill switch haptic data input device allow a greater variety of ways to hold a tool as long as it is being held firmly. Incorporating Bluetooth technology into the kill switch/tool circuitry may allow a user to have coded access to certain tools rendering the tools useless to individuals without coded access.

### EXAMPLE 3

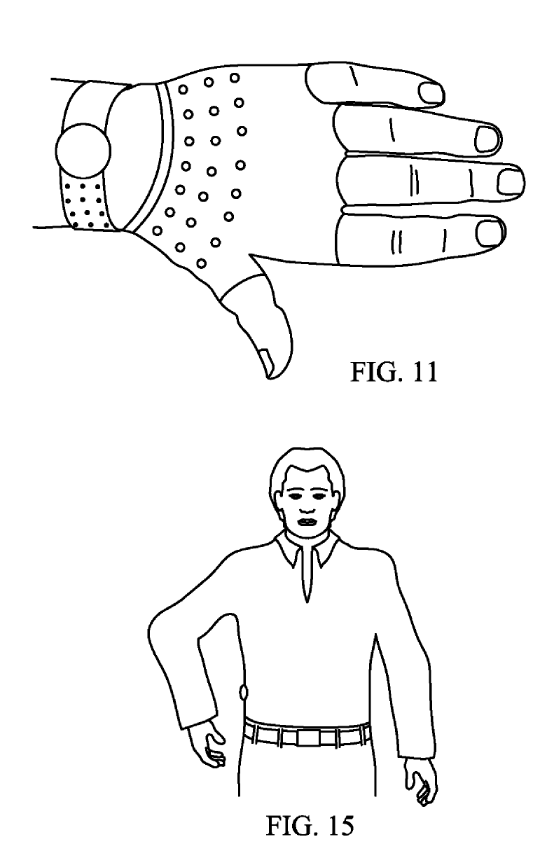

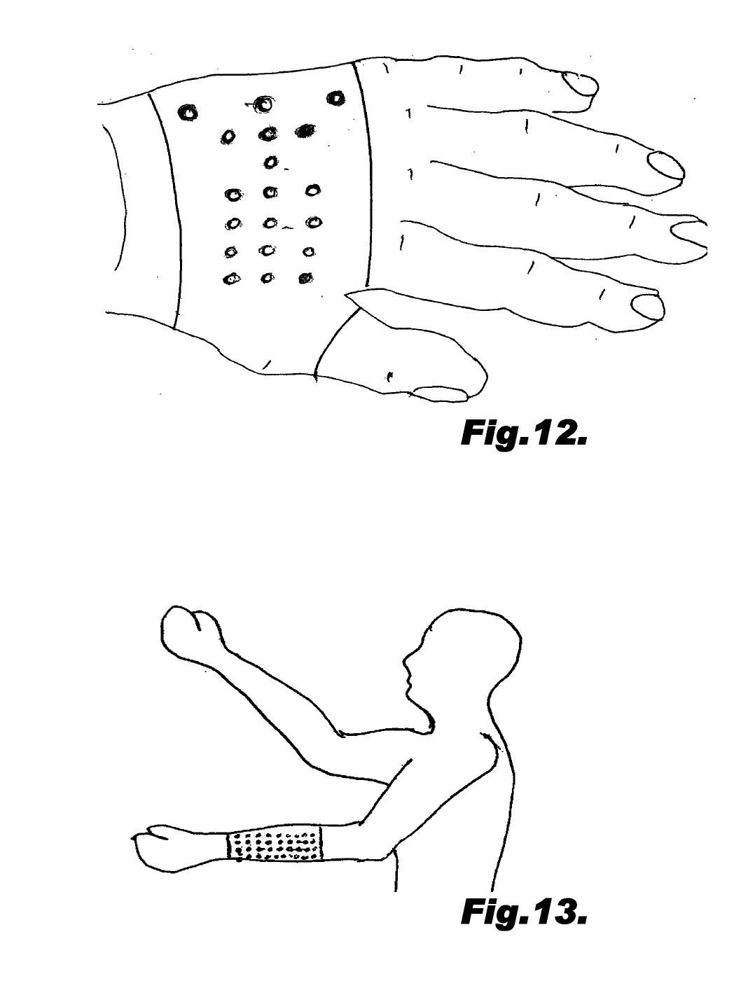

“Back of hand keyboard” as illustrated in FIGS. 11 and 12
FIG. 11 illustrates a back of hand keyboard with a character keyboard design.
FIG. 12 illustrates a back of hand keyboard with numeric keypad design.

A back of the hand keyboard could be designed as part of a glove. Other options include partial glove designs and large adhesive bandage designs. FIGS. 11 and 12 show a small character keyboard design and numeric keypad design. The user would use one hand to press the protrusions on the upper surface on the back of the other hand, operating similarly to the “thumb keyboard” of Example 1. Differences between the back of hand keyboard and the thumb keyboard would include larger spacing between tactile sensation producing elements because of comparative lack of sensitivity on the back of the hand; the tactile sensation producing elements would have points that would be more rounded and less acute due to the comparative thinness of the skin; and the keyboard/keypad layout would be different because of the different shapes of the respective body parts.

### EXAMPLE 4

“Forearm keyboard”

FIG. 13 illustrates a forearm keyboard. The forearm keyboard (FIG. 13) is an example of an alternate layout for the haptic data input device. This example will fasten to the inside or outside of the forearm and will be used analogously to the “thumb keyboard” of Example 1. It would have tactile sensation producing elements that may be broader and more widely separated than the back of the hand keyboard of Example 3. There would be variations in the design based on whether the keyboard is worn on the inside or outside of the forearm that would take into account the relative thickness and sensitivity of the skin.

This example has the potential for a very large number of keys if it wraps around from the outside to the inside of the forearm. A grid of 14×14 or 196 keys at a spacing of 9 to 10 mm would be conceivable, with the possibility of even larger grids by using closer spacing and/or extending the edges of the device to cover more area. The “forearm keyboard” could also be designed with fewer switches spaced more widely in order to serve as a numeric keypad to be used while worn under clothing. If it were designed to be worn and operated under clothing there would not be a need to have protruding reference points on the upper surface.

### EXAMPLE 5

“Thigh keyboard” as illustrated in FIG. 14. The thigh keyboard is an example of an alternate layout for the haptic data input device. This example will fasten to the outside of the thigh and will be used analogously to the “forearm keyboard” of Example 4. It would be likely to have broader and more widely spaced tactile sensation producing elements because of the relative lack of sensitivity of the skin in that area. As with the forearm keyboard, it could also be designed to be worn under one's clothing. An example that would be useful to individuals who are very comfortable with the classic QWERTY keyboard: Dual thigh keyboards could be designed as though they were a classic keyboard cut in half—much in the same fashion as existing ergonomic models. The dual keyboards would be operated with both hands simultaneously. There may also be the possibility of designing this example into the clothing itself—so people who are not prone to wear shorts to the office can still have their full keyboard accessible wherever they go.

### EXAMPLE 6

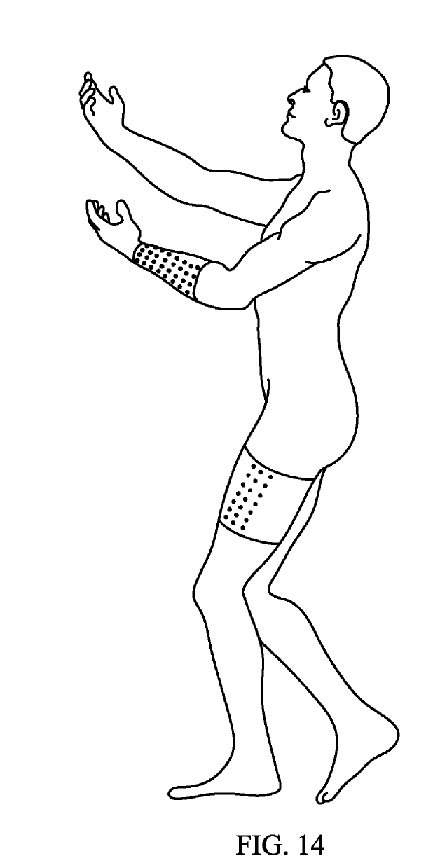

Clothing embedded haptic data input devices as illustrated in FIGS. 15-18. There are numerous possibilities for clothing embedded with haptic data input devices. It would be extraordinarily difficult to provide examples for every potential variation. As introduced in the prior examples, gloves could be embedded with “thumb keyboards”, “back of hand keyboards”, and passive kill switches. The forearm keyboard could be embedded in a shirt and the thigh keyboard could be embedded in trousers.

The four general ideas presented in this section represent possibilities that would not be obvious based on the prior examples.

### EXAMPLE 6.1

“Kill switch”—active

Active kill switch example is illustrated in FIG. 15. The active kill switch could be embedded in clothing in a location that is related to the body position of the user while using the tool or equipment. In an example of a chainsaw kill switch (FIG. 15), the haptic data input device could be embedded within a work shirt in the area of the lower ribs of the user's side at the point where the user's elbow would touch the ribs. The user could use his or her elbow to close the switch and turn off the chainsaw without needing to loosen or adjust his or her grip on the tool. Closing the circuit would send a signal to a transmitter in the shirt that is picked up by a receiver in the handle of the chainsaw which then turns off the saw.

### EXAMPLE 6.2

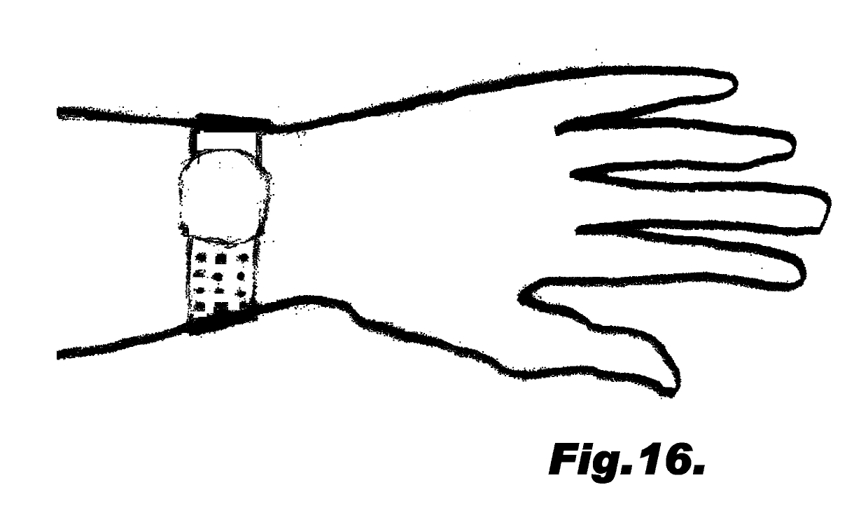

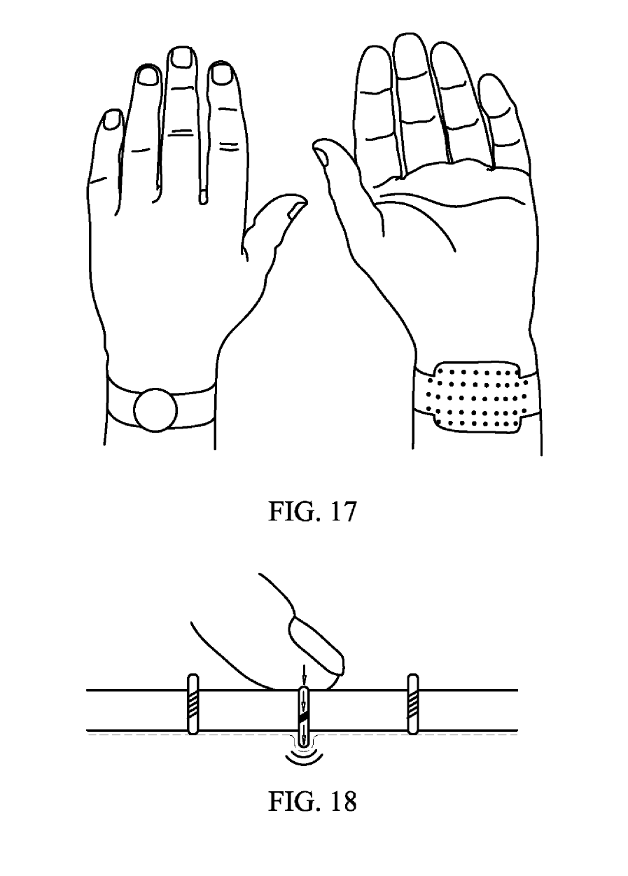

“Watchband/Wristband keypad”
FIG. 16 illustrates a watchband numeric keypad
FIG. 17 illustrates a watchband character keyboard
FIG. 18 illustrates an example of a possible nib/switch configuration for rigid or thick matrix

The watchband/wristband keypad could embody a variety of examples. One example (FIG. 16, the watchband numeric keypad) would be similar to the calculator watches of the 70s with the distinction that the tactile sensation producing elements would provide a sensation on the surface of the skin providing feedback as to which switches are being compressed. It would, of course, have many more applications than the old watches including some of the latest innovations in mobile communication technology. Another example would have a more extensive keypad on the opposite side of the watch (FIG. 17), usable by turning the wrist or rotating the watch to the opposite side of the wrist. The example of a possible nib/switch configuration for rigid or thick matrix (FIG. 18) would be one way to transfer the stimulus from the upper buttons of the example of the watchband numeric keypad (FIG. 16) to the skin of the user.

The tactile sensation producing elements would probably be designed differently depending upon whether they were to be on the inside or the outside of the wrist. Outside of the wrist they could be more acute than on the inside of the wrist because of relative lack of sensitivity and thickness of skin. The tactile sensation producing elements for the inside of the wrist may be augmented with temperature changes when activated to take advantage of the temperature sensitivity of the area—similar to the feeling of metal at slightly less than room temperature pressed against the inside of the wrist.

### EXAMPLE 6.3

Glove

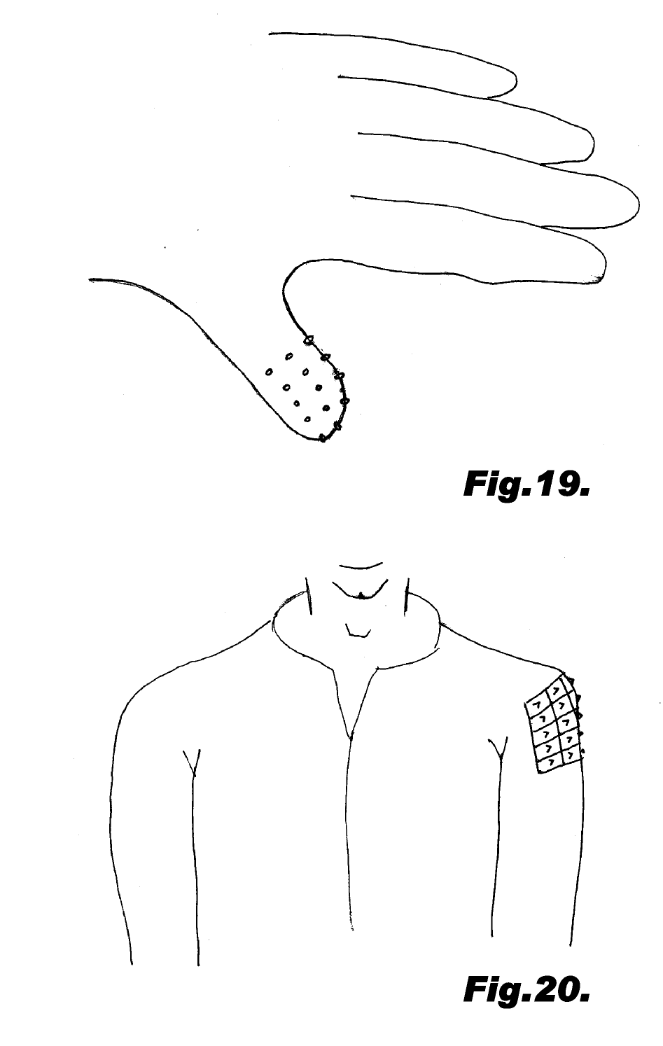

FIG. 19 illustrates an exemplary glove. The example of a glove (FIG. 19) could embed the haptic data input device within the thumb of the glove in the form of a phone style numeric keypad. The user could depress the switches while wearing the glove and have haptic feedback on the surface of the skin of the thumb. The sliding mechanism as illustrated in FIG. 18 could serve to transfer the pressure from the upper surface. This glove could be used to allow the user to operate a cell phone without needing to retrieve something from one's pocket or needing to remove a glove to dial. For example, it would also circumvent difficulties in using voice activated commands on a noisy motorcycle. A device such as this could enhance the safety of the operator who needs to communicate while in transit.

### EXAMPLE 6.4

Jacket

FIG. 20 shows an exemplary jacket. An example of such a jacket (FIG. 20) could have the embedded haptic data input device in the upper arm or shoulder area. The jacket would likely have comparatively widely spaced tactile sensation producing elements.

This is an example where the tactile sensation producing elements would not be expected to have direct contact with the surface of the skin. The elements may need to be hard and may need to be given enhanced force to be felt through clothing worn underneath the jacket. It may be useful to have an adjustable force function in order to more correctly match the sensitivity of the user. The example in FIG. 18 illustrates a cross section of what the switches may look like, though they would be enlarged and more widely separated. They would be covered with a layer of material on both the inside and outside to prevent moisture from entering the switch mechanisms.

A possible application would be a numeric keypad to be used for personal communications. The user would thereby have the communication device always at the ready. There could also be function that sends out an emergency signal if two or more switches are simultaneously closed for more than a certain length of time in order to be located after an avalanche or fall. This safety aspect could also be enhanced by placing additional switches in other locations on the jacket. It would need a user option to disable the emergency signal once triggered but prior to its broadcast in order to prevent false alarms.

### EXAMPLE 7

Roof of mouth keyboard

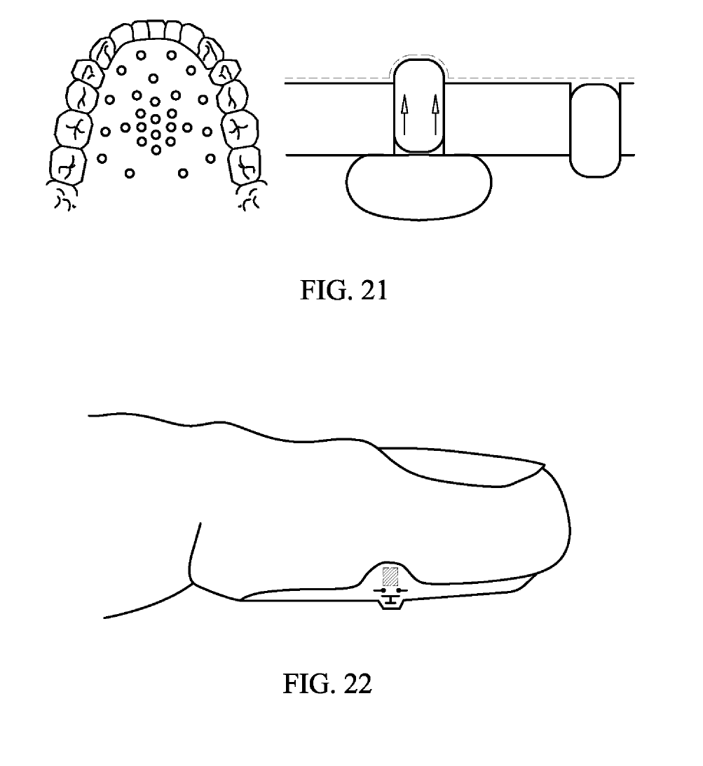

FIG. 21 Illustrates a roof of mouth keyboard. The example of a roof of the mouth keyboard could be designed as a flexible retainer with small protruding tactile sensation producing elements situated against the skin of the roof of the mouth. Pressing on the “upper” surface of the keyboard with the tongue would close the switch and transfer pressure to the roof of the mouth. One possibility for design could be similar to the membrane switch cross section shown in FIG. 8. Both the tactile sensation elements and the protruding reference points would be rounded and smooth in order to avoid irritating the tongue or the roof of the mouth.

On the right side of FIG. 21 is another example of a switching mechanism in case the membrane switch design is too thin to accommodate all the components necessary to operate the roof of mouth keyboard. This example is similar to the illustration in FIG. 18. The sliders would be covered by a thin membrane to keep moisture out of the device. It would also be conceivable that the roof of mouth keyboard combine both types of switches, with the membrane switches out near the teeth and slider switches in toward the middle and back of the roof of the mouth.

This example could be used by individuals with traumatic neck injuries and other severe conditions to operate wheelchairs, use environmental controls, home electronics, computers and other communication devices. In an even more specialized circumstance, the roof of mouth keyboard could be designed with just two or three switches and the tongue side of the device could be enhanced with flavors such as sweet and bitter. This could be helpful in assessing and accommodating the cognitive function of individuals for whom it is difficult to discern using more conventional methods.

### EXAMPLE 8

Miniaturized pointing devices

The embedded isometric joystick shown in FIG. 22 may allow a person to use a graphical computer pointing device wherever they are. The isometric joystick will be embedded within a protruding tactile sensation producing element. It is operated by pressing the protruding reference point against another object in order to activate it. The user could press it against a table, desk, any solid surface, and could even press it against their own thumb. It would operate analogously to the isometric joysticks being placed on laptop keyboards between the “g” and “h” keys. Directional lateral pressure against the joystick will translate to pointer movement on the computer screen.

Clicker buttons could be placed on the other fingers. The design of the clicker buttons would be similar to the “passive kill switch on thumb” as described in Example 2. With this configuration, a user could conceivably use a “thumb keyboard” (Example 1), “back of hand keyboard” (Example 3), or the “forearm keyboard” (Example 4), and operate a pointing device with the hand not being used to press the “keys”.

What is claimed is:

1. A haptic data input device as shown and described.
